(19) United States
(12) Patent Application Publication
(10) Pub. No.: US 2023/0252504 A1
(43) Pub. Date: Aug. 10, 2023

(54) PREDICTIVE ANALYTICAL MODEL FOR FINANCIAL TRANSACTIONS

(71) Applicant: GEOSPATIAL ANALYTICS, INC., Phoenix, AZ (US)

(72) Inventor: Brian C. Jordan, Phoenix, AZ (US)

(21) Appl. No.: 18/149,765

(22) Filed: Jan. 4, 2023

Related U.S. Application Data
(60) Provisional application No. 63/296,216, filed on Jan. 4, 2022.

(51) Int. Cl. G06Q 30/0202

(52) U.S. Cl. CPC G06Q 30/0202

(57) ABSTRACT

Systems and methods for forecasting commercial financial transaction scores are disclosed. The systems and methods receive a series of independent variables that represent attributes of a specific commercial financial transaction. The systems and methods scale and normalize the series of independent variables. Additionally, the systems and methods assemble the scaled and normalized series of independent variables. The systems and methods also apply weightings to the assembled scaled and normalized series of independent variables and predict a score for the specific commercial financial transaction.

### CROSS REFERENCE TO RELATED APPLICATION

This application claims priority to and the benefit of U.S. Provisional No. 63/296,216 filed Jan. 4, 2022 and entitled “PREDICTIVE ANALYTICAL MODEL FOR FINANCIAL TRANSACTIONS.” The foregoing application is hereby incorporated by this reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to financial transaction systems, and in particular to systems for analyzing financial transactions.

### BACKGROUND

Contractual transactions typically require monetary consideration in return for the item or service being procured. However, few of these transactions are so simple as to have just a single value (i.e. dollar amount) for the financial compensation, particularly for commercial transactions. Rather, there may be multiple elements to the payment, such as a payment stream over time that varies in amount. Financial incentives or penalties may be additional elements. All of these financial contractual provisions vary with each alternative, and accurately determining the lowest cost alternative can be challenging, time-consuming, and/or prone to inaccuracies. As such, it may be difficult to accurately assess the actual value of the financial elements. These difficulties may be further compounded for individuals without technical experience in the corresponding industry. Accordingly, developing an easy to use predictive analytical model for financial transactions or to measure or predict one or more of the other aspects of such transactions discussed above may be advantageous.

### SUMMARY

A method of forecasting commercial financial transaction scores (the dependent variable) includes receiving, at a computing system, a series of independent variables that represent attributes of a specific commercial financial transaction, as well as other independent variables, such as attributes of the financial transaction and negotiation strategy, that may have a correlation with the value of the dependent variables. The method includes configuring the system to the unique set of variables that are relevant to any given set of circumstances. The method includes scaling and normalizing the series of independent variables. Additionally, the method includes assembling the scaled and normalized series of independent variables. The method also includes applying weightings to the assembled scaled and normalized series of independent variables and analyzing data relative to past results from industry data and from portfolio data from the user. The method includes predicting a score for the specific commercial financial transaction.

A device for forecasting commercial financial transaction scores includes at least one processor and a memory coupled to the at least one processor. The memory includes instructions causing the at least one processor to receive, at the device, a series of independent variables that represent attributes of a specific commercial financial transaction. The memory also includes instructions causing the at least one processor to scale and normalize the series of independent variables. Additionally, the memory includes instructions causing the at least one processor to assemble the scaled and normalized series of independent variables. The memory also includes instructions causing the at least one processor to apply weightings to the assembled scaled and normalized series of independent variables and analyze data relative to past results from industry data and from portfolio data from the user. The method includes predicting a score for the specific commercial financial transaction.

An apparatus for forecasting commercial financial transaction scores is disclosed. The apparatus is configured to receive, at a computing system, a series of independent variables that represent attributes of a specific commercial financial transaction. Additionally, the apparatus is configured to scale and normalize the series of independent variables. The apparatus is also configured to assemble the scaled and normalized series of independent variables. Additionally, the apparatus is configured to apply weightings to the assembled scaled and normalized series of independent variables and analyze data relative to past results from industry data and from portfolio data from the user. The method includes predicting a score for the specific commercial financial transaction.

### BRIEF DESCRIPTION OF THE DRAWINGS

With reference to the following description and accompanying drawings:

FIG. 1 illustrates a generic calculator;

FIG. 2A illustrates a menu screen for an analytic calculator in accordance with an exemplary embodiment;

FIG. 2B illustrates a single scenario analytic calculator in accordance with an exemplary embodiment;

FIG. 2C illustrates a model of a calculator output screen in accordance with an exemplary embodiment;

FIG. 2D illustrates a model of a calculator input and output screen with a first scenario calculation and a second scenario calculation in accordance with an exemplary embodiment;

FIG. 2E illustrates a model of a calculator comparative analytics input and output menu in accordance with an exemplary embodiment;

FIG. 2F illustrates a model of a calculator comparative analytics input and output menu comprising the input and output screen of FIG. 2D and the input and output menu of FIG. 3E in accordance with an exemplary embodiment;

FIG. 2G illustrates a model of a calculator comparative analytics and data visualization input and output menu in accordance with an exemplary embodiment;

FIG. 3 illustrates a model of a lease provision diagnostics visualization in accordance with an exemplary embodiment;

FIG. 4 illustrates a model of a calculator comparative analytics menu for analyzing multiple scenarios for alternative contracts in accordance with an exemplary embodiment;

FIG. 5A illustrates a model of a calculator normalization input and output capable of comparing multiple financial transactions with a subject financial transaction in accordance with an exemplary embodiment;

FIG. 5B illustrates a model of a calculator normalization input and output capable of comparing multiple financial transactions with a subject financial transaction in accordance with an exemplary embodiment;

FIG. 6 illustrates a low code platform for analytic calculator modifications in accordance with an exemplary embodiment;

FIG. 7 illustrates an on-line app library including the analytic calculator available for download onto a mobile device;

FIG. 8 illustrates a location module for the analytic calculator in accordance with an exemplary embodiment;

FIG. 9 illustrates a module creation menu for the analytic calculator in accordance with an exemplary embodiment;

FIG. 10A illustrates exemplary data extraction, transform, and load capabilities for the analytic calculator;

FIG. 10B illustrates a module records for mapping data from a source in accordance with an exemplary embodiment;

FIG. 11 illustrates exemplary statistical methods utilized in the analytic calculator in accordance with an exemplary embodiment;

FIG. 12 is a flow chart illustrating an exemplary method in accordance with an exemplary embodiment; and

FIG. 13 is a system diagram illustrating an example system in accordance with the systems and methods described herein.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from principles of the present disclosure.

For the sake of brevity, the connecting lines shown in various figures contained herein are intended to represent exemplary functional relationships and/or physical couplings between various elements. It should be noted that many alternative or additional functional relationships or physical connections may be present in predictive analytical models for financial transactions.

Almost any contractual transaction contains the requirement of monetary consideration in return for the item or service being procured. However, few of these transactions are so simple as to have just a single value (i.e. dollar amount) for the financial compensation. Rather, there can be multiple elements to the payment, such as a payment stream over time that varies in amount. Financial incentives or penalties may be additional elements. The actual value of the financial elements can be difficult to assess accurately. For example, if a person is faced with buying an automobile, they may be faced with the decision around a purchase or a lease. The purchase may provide for a specific purchase price with a specific interest rate, or in allow for payments to be deferred until a future date, or allow for cash back to the purchaser at the time of purchase. All of these financial contractual provisions vary with each alternative, and determining the lowest cost alternative is challenging. This consumer-based example can be very simple compared to much larger commercial transactions that can have dozens of financial variables that impact the actual value of the monetary consideration. Furthermore, besides comparing two alternative sets of monetary provisions for a specific contract, it may be desirable to compare two or more competing alternatives (multiple potential contracts). The desire to compare historical results across a portfolio of a specific transaction type can provide business intelligence to determine and/or adjust current negotiation strategies or create new strategies. The information obtained from assessing an entire portfolio can provide trending and provide the basis for various types of analytics, including diagnostic, predictive and prescriptive analytics.

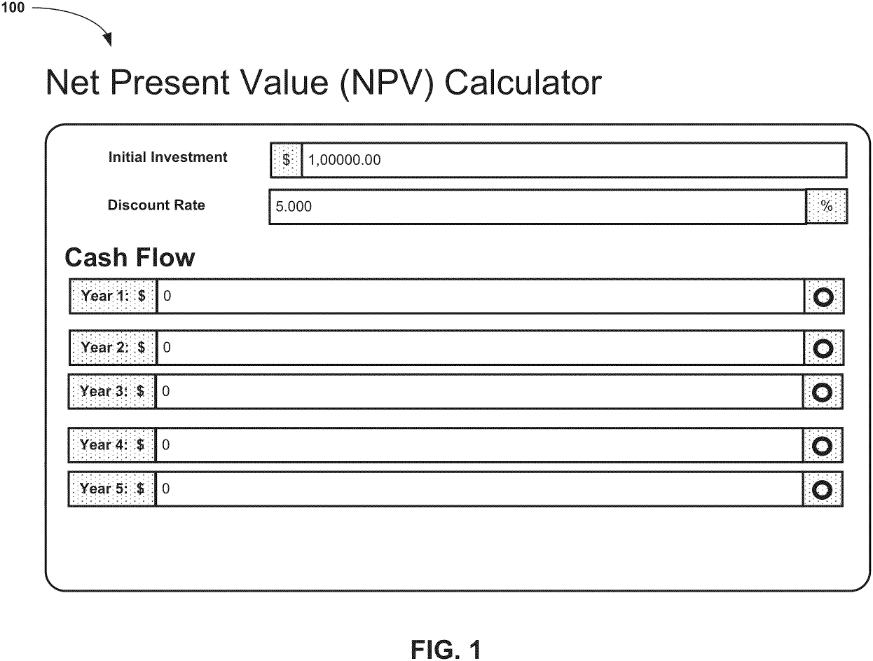

The number of types of financial transactions are extensive. Each has its own unique set of terms that impact the financial outcome, even though the mathematical functions and operations relative to the monetary exchange are constant. Therefore, being able to model scenarios with respect to the appropriate set of terms provided by a given transaction type is desirable to assure the correct calculation and outcome. Utilizing generic software calculators (see FIG. 1) that provide only basic financial calculations tends to require the user to have extensive expertise to assure that all of the nuances of a specific transaction type are addressed. In addition, generic calculators typically are single dimensional, and therefore typically require the user to manually aggregate the results of multiple calculations from one, or many different calculators. In addition, these generic calculators are not structured to allow for comparative analysis of multiple scenarios, and are designed for a single output, requiring the user to manually conduct the comparative analysis.

The predictive analytical model for financial transactions (also referred to herein as an analytic calculator), as described herein, allows a user to model a specific financial transaction and to create various scenarios to determine the outcomes of any given set of variables. The user can then select the optimal outcome to pursue based upon the user’s specific requirements and constraints. The analytic calculator of the present disclosure allows a user to leverage traditional financial models—such as Net Present Value (NPV) as applied to payment streams—but extends the ability to accurately value other elements of the transaction relative to any monetary terms. The analytic calculator of the present disclosure may go beyond simple input/output calculator tools by creating the ability for the user to leverage other data sets to compare outcomes of various modeled scenarios relative to historical outcomes. The analytic calculator of the present disclosure provides guidance to the user on modeling any given scenario and then presents preset options (e.g., an analytic calculator library (AC library)) based on algorithms and mathematical order of operations. However, an administrative tool may be provided that is part of the solution and allows the user to modify the preset options or to create a total original model from any given calculator template in the AC Library. The analytic calculator of the present disclosure can then be extended to compare multiple contracts dealing with the same transaction, and ultimately assess an entire portfolio of contracts of a specific transaction type. Results can be saved to a database within a module that can be selected for various contract types from a module library. The module can then be modified or new modules can be created to retain the inputs from the analytic calculator for further analysis. In addition, user datasets from other databases, spreadsheets and other sources can be imported through administrative functions to allow for further comparisons and analysis.

FIG. 1 illustrates a generic software calculator 100 that provides only basic financial calculations. Generic calculators, such as calculator 100 for example, tend to require the user to have extensive expertise to assure that all of the nuances of a specific transaction type are addressed.

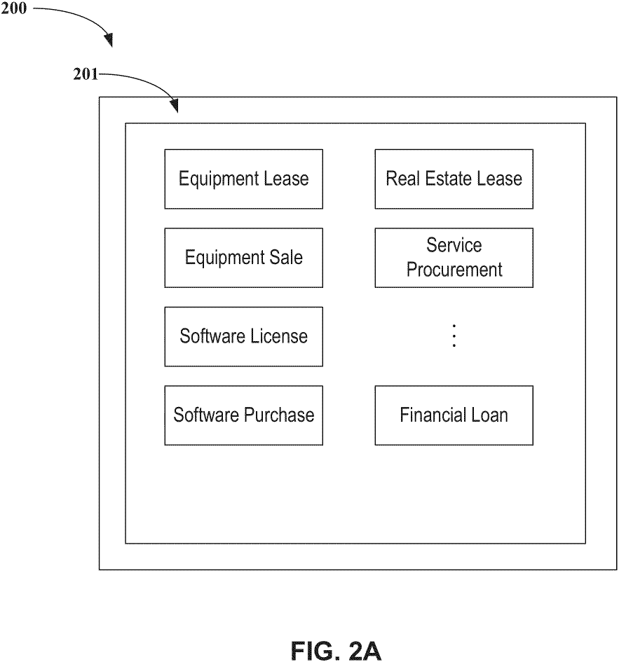

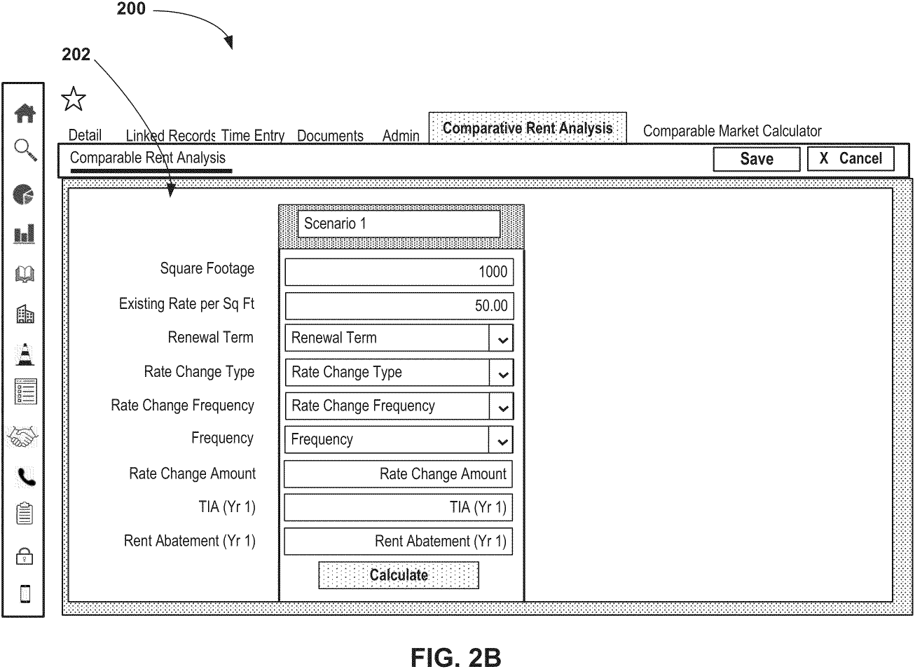

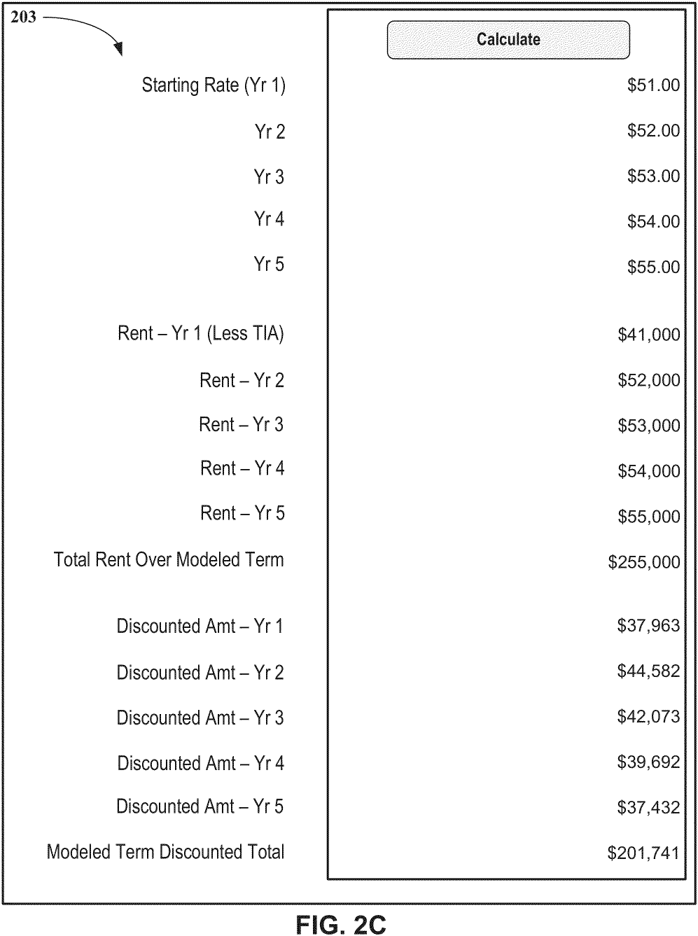

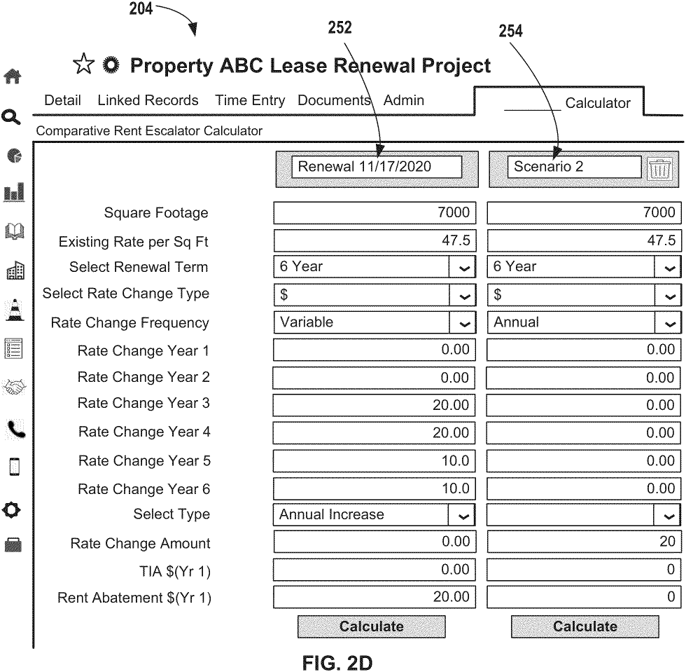

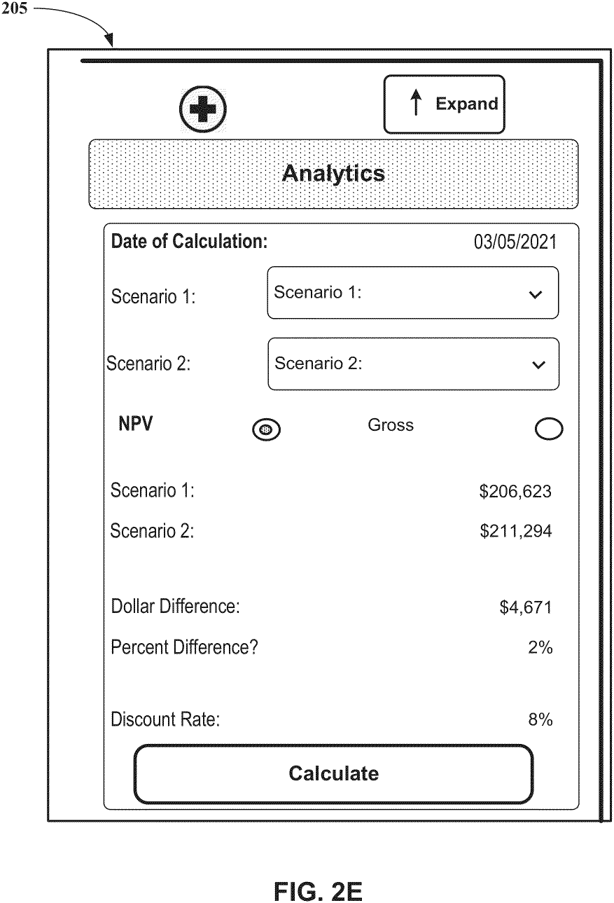

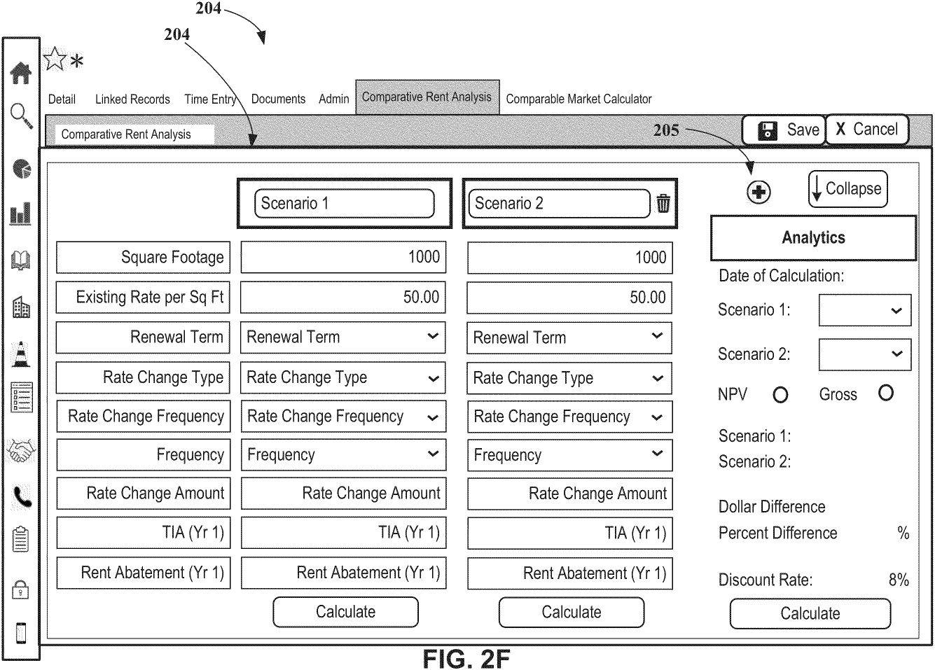

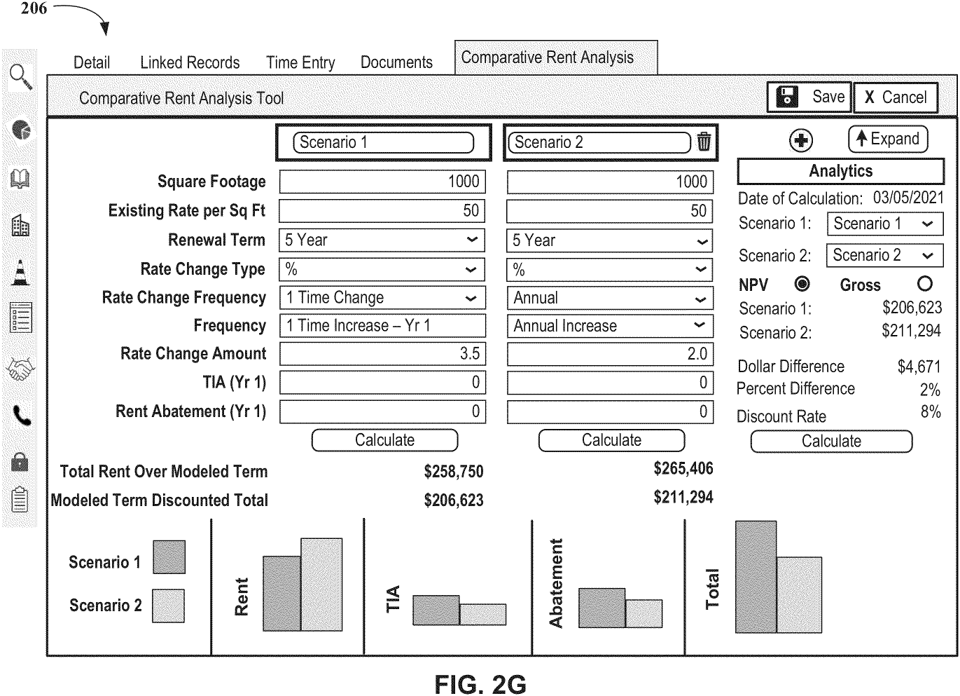

FIG. 2A is a diagram illustrating an example model of a menu screen 201 for an analytic calculator 200 of the present disclosure, in accordance with an exemplary embodiment. To utilize the calculator 200, the user launches the software application and is then presented by the ability to select a specific preconfigured calculator that accommodates the type of transaction being contemplated, such as: equipment lease, equipment sale, software license, software purchase, real estate lease, service procurement, and financial loan. It should be understood that the list of preconfigured calculators may include other preconfigured calculators for other types of transactions.

If the user prefers, the calculator 200 can present a series of diagnostic questions using artificial intelligence based on skip logic and branching capabilities to be answered by the user to help identify and recommend the appropriate calculator. As an example, the user may be provided with the following diagnostic questions:
Is the transaction structured for:
   Personal Property
   Real Property
   Services
   Other
Answer: Real Property
Is the real estate transaction for a:
   Purchase
   Lease
   Easement
   Other
Answer: Lease
Is the Lease:
   New
   Renewal
   Disposition
   Other
Answer: Renewal
Are you the:
   Lessee
   Lessor
Answer: Lessee

Upon answering the complete set of questions, the calculator 200 may then recommend the appropriate preconfigured solution for the specific transaction that is contemplated. For example, in response to a user making the above-mentioned example selections (i.e., real property, lease, renewal, and lessee), the calculator 200 may provide the single scenario analytic calculator 202 for a real property lease (see FIG. 2B).

### Modeling a Financial Transaction (Single Contract - Alternative Monetary Terms)

FIG. 2B illustrates an example single scenario analytic calculator 202. Upon answering the complete set of questions, the user may be provided access to the appropriate analytic calculator and can begin analysis. Because the type of transaction has been identified (real property lease) the analytic calculator 202 that is presented has specific variables related to that type of transaction (see FIG. 2B). The user may then populate some basic information needed to perform the calculation, such as the square footage of the leased premises, as well as the proposed rate per square foot. Artificial intelligence (AI) may be utilized to clarify and further define specifics of any give variable to assure that the calculation is correct. In this example, the analytic calculator 202 may query:
Is the Square Footage:
   Gross
   Net
   Usable
   Other
Is the Cost per Square Foot:
   Triple Net
   Gross
   Modified Gross
   Other

This second layer of AI may assure that the contemplated calculation has anticipated all of the variations to the financial structure that is going to be analyzed.

If the cash payments are going to change over time (such as annual adjustments) then those are designated, as well as other monetary elements of the transaction, such as tenant improvement allowance and rent abatement. All variables relative to the monetary provisions of the transaction may be captured. Within the administrative tool the user can define the type of financial model that is desired to apply to the transaction, as well as any assumptions desired by the financial model. In this example, the user has designated Net Present Value (NPV) as the financial model and has designated the required assumption of discount rate. After populating the required fields, the user can then calculate the NPV and view the total cost of the transaction (see FIG. 2C).

FIG. 2C illustrates an exemplary model of a calculator output screen 203. The calculator output screen 203 may provide the results of the initial calculation. The user now has the NPV of the transaction as proposed (baseline). However, if there are alternatives that are being offered, or that the user intends to request through negotiations, then it may be desirable that the NPV of these alternatives are also determined and compared to the baseline. This can be done by adding an additional set of variables that can then be populated, calculated and compared to the baseline (see FIG. 2D).

FIG. 2D illustrates an exemplary model of a calculator input and output screen 204 with a first scenario calculation 252 and a second scenario calculation 254. The first scenario calculation 252 and a second scenario calculation 254 may be presented in a side-by-side fashion for ease of comparing each scenario. A user can continue to add as many scenarios as needed for comparative purposes.

FIG. 2E illustrates an exemplary model of a calculator comparative analytics input and output menu 205. The analytic calculator 200 may provide the delta between the NPV’s of the scenarios being analyzed. Once the user has provided the required inputs, the calculation can then be performed. The user may then be presented with the analysis of the comparisons of the two scenarios (see FIG. 2E).

The user may further be presented with the inputs of the two scenarios, the comparative analytics, and/or a data visualization (e.g., a chart and/or graph) that easily distinguishes the variances between the two scenarios for further action by the user (see FIG. 2G).

FIG. 2F illustrates an exemplary model of a calculator input and output screen 211 comprising the calculator input and output screen 204 of FIG. 2D and the calculator comparative analytics input and output menu 205 of FIG. 2E.

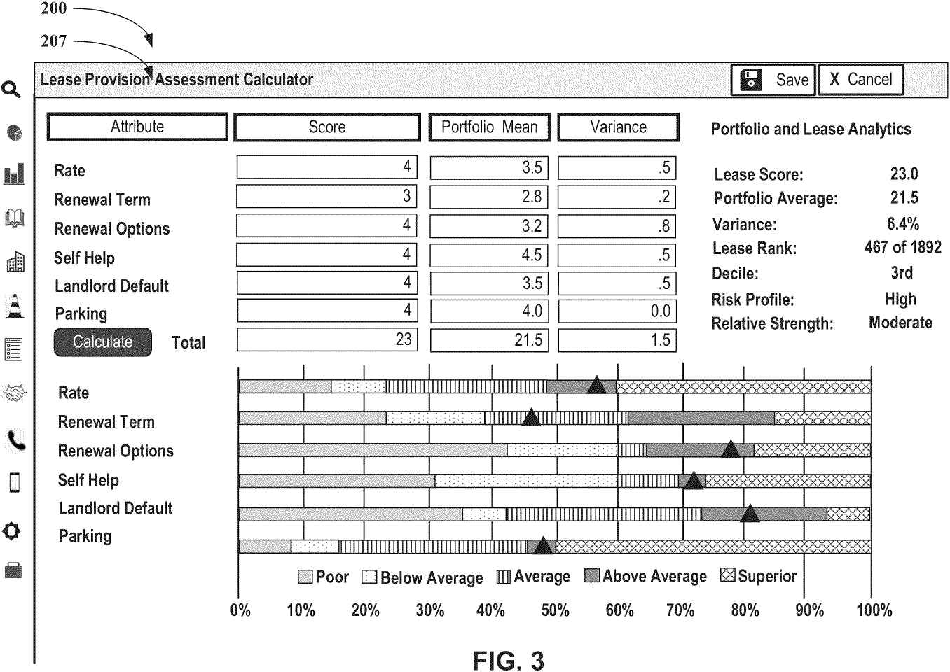

FIG. 2G illustrates an exemplary model of a calculator comparative analytics and data visualization input and output menu 206. Now that the two scenarios have been compared, the user can determine the optimal course of action to take regarding selecting the best scenario for the desired outcome. Using the specific values of that scenario, the user can now calculate the financial provisions, along with other applicable provisions (as desired) against other portfolios of similar leases. With additional reference to FIG. 3, this may consist of a data set from the user’s own lease portfolio. This analysis allows for diagnostical analytics to be performed, such as comparing quintile segmentation of specific lease provisions and the relative ranking of the subject provision(s) (see FIG. 3). This allows the user to determine the relative strength of the subject lease as compared to the portfolio, the likelihood of improving negotiating better terms based on past results, and determine the best course of action to achieve the desired outcome.

FIG. 3 illustrates an exemplary model of a lease provision diagnostics visualization 207. For diagnostics of a real estate portfolio, the diagnostics visualization 207 may include analysis of factors such as lease rate, renewal term, renewal options, self-help, landlord default, parking, etc. However, the parameters will vary based on the particular type of transaction being analyzed. A score for each particular parameter may be provided in the diagnostics visualization 207.

### Modeling a Financial Transaction (Single Transaction - Alternative Contracts/Monetary Terms)

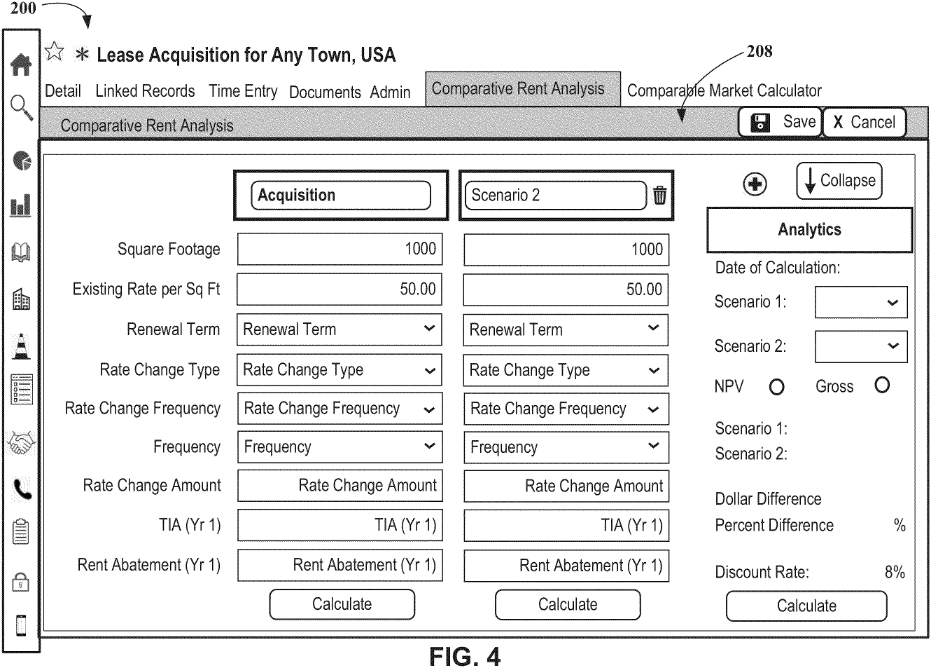

If the user is not comparing alternatives for financial provisions of a single contract, but comparing two different contracts for two different financial transactions, then the user can designate that, and the analytic calculator 200 may change the variables as required for the modification being made (see FIG. 4).

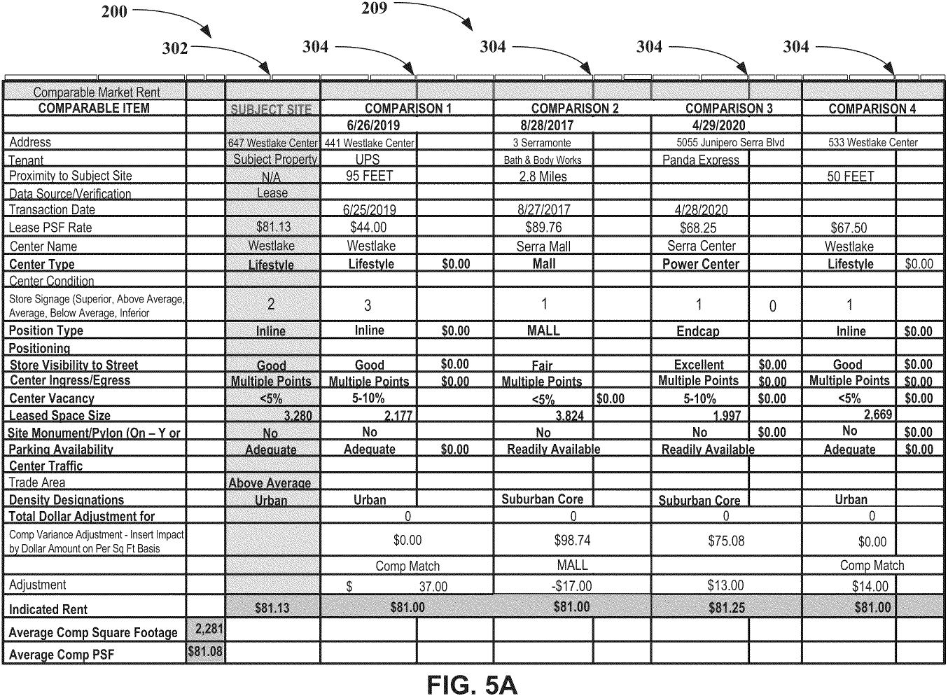

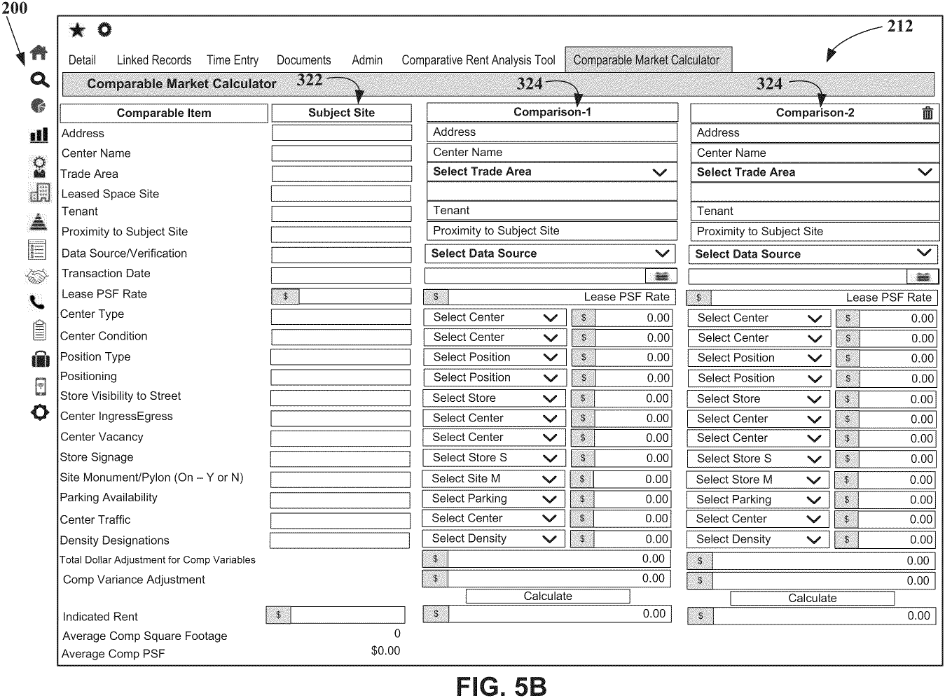

FIG. 4 illustrates an exemplary model of a calculator comparative analytics menu 208 for analyzing multiple scenarios for alternative contracts. All of the capabilities that were demonstrated regarding the single contract may be applied to alternative contracts. However, because the analysis is no longer premised on the other terms and conditions being identical, as in the example which reviewed alternative monetary terms for the same contract, now there is a desire to “normalize” the contracts being revised to account for differences in such quantity of goods or services being purchased, differences in features, quality attributes of the goods or services, etc. In the real estate lease example, this would be such variables as total square footage, desirability of location, age of facility, desirability of amenities, etc. The analytic calculator 200 therefore may present the user with a matrix to allow for the normalization of the different potential leased premises, and therefore then normalize the inputs to the analytic calculator 200 (see FIG. 5A and FIG. 5B).

FIG. 5A and FIG. 5B illustrate exemplary models of a calculator normalization input and output 209 and a calculator normalization input and output 212, respectively, each calculator normalization input and output 209, 212 capable of comparing multiple financial transactions with a subject financial transaction, in accordance with an exemplary embodiment. The illustrated calculator input and output screen 209 includes data for a subject site 302 and data for four (4) comparison sites 304. The illustrated calculator input and output screen 212 includes data for a subject site 322 and data for two (2) comparison sites 324. However, various financial transactions other than real estate may be analyzed. The illustrated calculator input and output screen 300 includes data such as address, tenant, proximity to subject site (for comparison sites 304), data source, transaction date, lease price per square foot (PSF) rate, center name, center type, center condition, store signage information, position type, positioning, store visibility to street, center ingress/egress, center vacancy, leasing space size, site monument/pylon, parking available, center traffic, trade area, density designation, total dollar adjustment for various items, and adjustment. The illustrated calculator input and output screen 300 also includes an indicated rent output, as well as averages, such as average comp PSF.

The address may be the physical address of the property. The tenant may be the name of the tenant of the comparison property or a listing of “subject property” for the subject property. The proximity to subject site may be the distance from the subject property to the comparison site 304, e.g., in feet, meters, or any other unit of distance that a user of the system may determine to be useful. The data source may provide an indication of where data for a given property comes from, such as the lease or other source of information. The transaction date may be the lease date for a comparison site 304. The lease price per square foot (PSF) rate may be expressed in dollars or other currency. Furthermore, the lease PSF may indicate the price per square foot of the particular property, e.g., subject site 302 or comparison sites 304.

The center name, center type, and center condition may all be indications of what center or location the subject site 302 is located in. Store signage information may provide information on the sign-related advertising for the site. Position type, positioning, and store visibility to street may provide information on the set up of the subject site 302. Center ingress/egress provides information on how potential customers may access the property. Center vacancy provides information on vacancy rates, which may impact traffic to the property. The leasing space size may directly impact total cost and may be an important factor in deciding on a property to lease. The site monument/pylon information relates to on-site signage. The parking available and center traffic may impact abilities for customers to reach the site. The trade area may be a geographic area within which a business enterprise or center of retail or wholesale distribution draws most of its business, the wholesale trading area for groceries of the city, a department store’s trading area, or the trading area of a shopping center. The density designation may indicate the population within a given geographical area surrounding the subject property.

The total dollar adjustment for various items may be a space for entering various monetary adjustments that may be defined by a user and may be named within the calculator, e.g., “comp variance adjustment - insert impact by dollar amount on per square foot basis.” Contrary to the name, “total dollar adjustment...,” it will be understood that other units of monetary value may be used, rather than dollars.

Store signage information may include one of “superior,” “above average,” “average,” “below average,” or “inferior.” These may be indications based on opinion. To provide a more consistent and objective standard of assessment, the administrative capabilities of the system may allow defining of the elements used for the rating (distance of visibility, degrees of visibility, etc.) or to provide help files providing the definition of each rating. The variable being scaled may have a nominal value that is populated in the calculator, such as parking stalls per 1000 square feet of retail, or average household income for a defined geographic area of a one-mile radius around the subject property. The tool may have preset scales based upon the profile of the user. However, the system also may have a library of templates that can modify the preset scales based upon selections made by the administrative tool.

If the preset scales or library template scales do not adequately address the specific attributes of a business, a user, or of the independent variables being utilized by the specific parameters of the needed analysis, the administrative tool may be used to determine what the appropriate scale would be and to implement the appropriate scale within the system. For instance, the system may present a preconfigured scale for parking ratios, so that ≥ 8 per 1000 sq. ft. was excellent (a score of 5), 5-7 per 1000 was above average (a score of 4), etc. However, Retailer “B” owns a chain of movie theaters and has intensive parking requirements. Therefore, the parking ratio ratings could be recalibrated to reflect this, so that ≥ 12 per 1000 sq. ft. was excellent (a score of 5), 9-11 per 1000 was above average (a score of 4), etc.

### Modifying AC Library Calculators (No Code Platform)

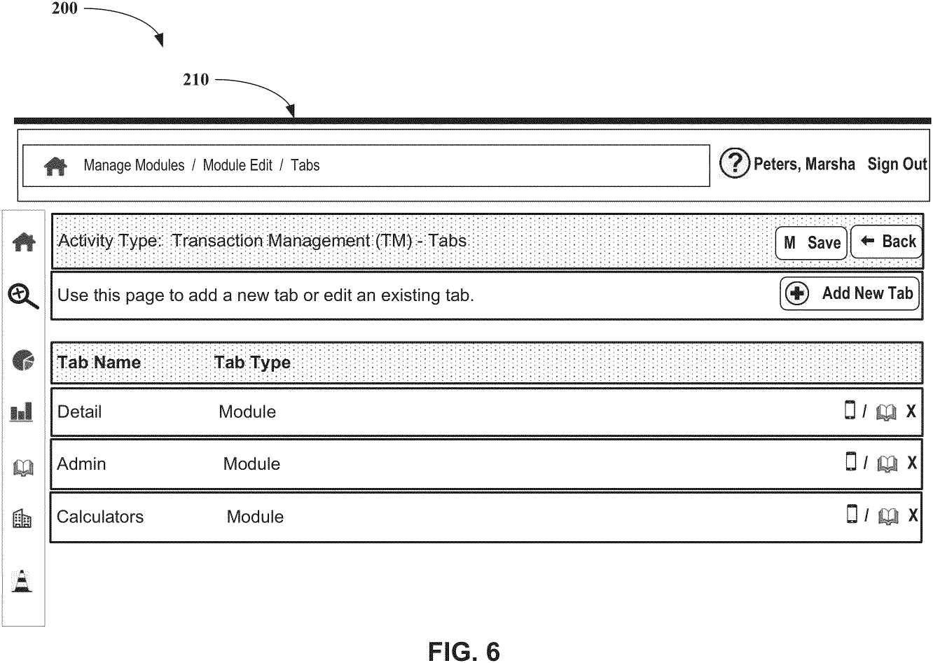

FIG. 6 illustrates an exemplary no code platform 210 for analytic calculator 200 modifications, in accordance with an exemplary embodiment. The analytic calculator 200 may include a library of calculators in which the user can directly select the appropriate calculator, or can utilize the AI capabilities of the analytic calculator 200 to have the application determine the appropriate calculator. However, business contracts and contract requirements are constantly evolving. It may be desirable for the analytic calculator to be able to quickly adapt to new variables of any given financial provision of a contract. To fulfill this need, the analytic calculator 200 may provide a no code platform 210 for calculator modifications. No code is a visual approach to software development. No code abstracts and automates steps in the application development that enables rapid delivery of software solutions without knowing traditional programming languages. Trained users can use the administrative tools to create and modify areas of the software application (see FIG. 6). For instance, if the underlying algorithm to a specific calculator was (a × b) + c = Σ, the user could modify the operators and order of operations by modifying the precedence rules to create a + (b × c) = Σ. If new variables were needed (d) those could be added as well, such as a + (b × c) - d = Σ.

### Module Library and Saving Analytic Calculator Data Inputs and Outputs

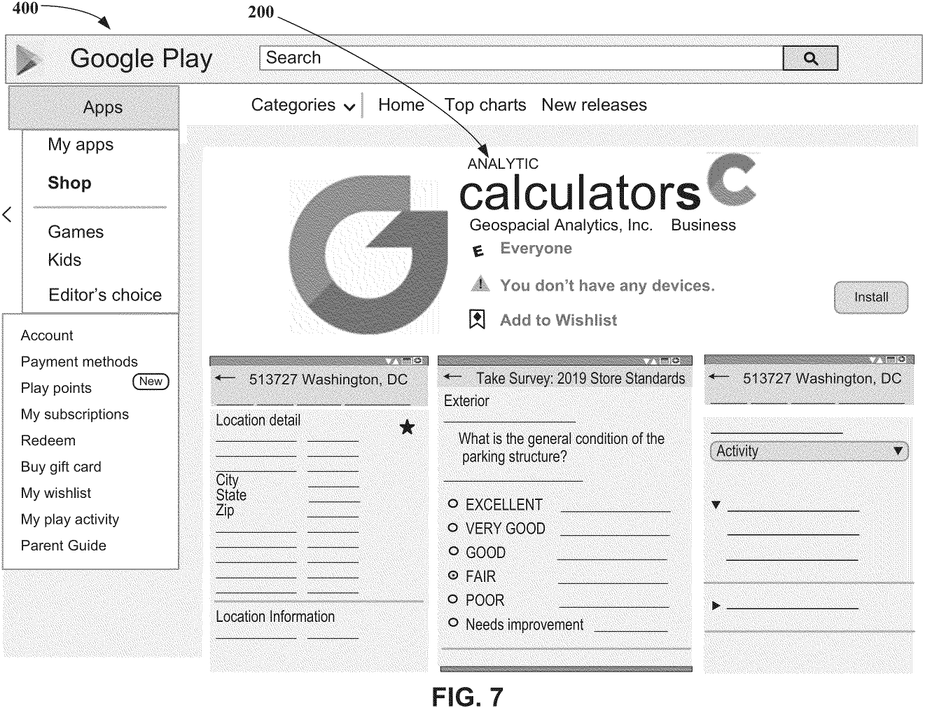

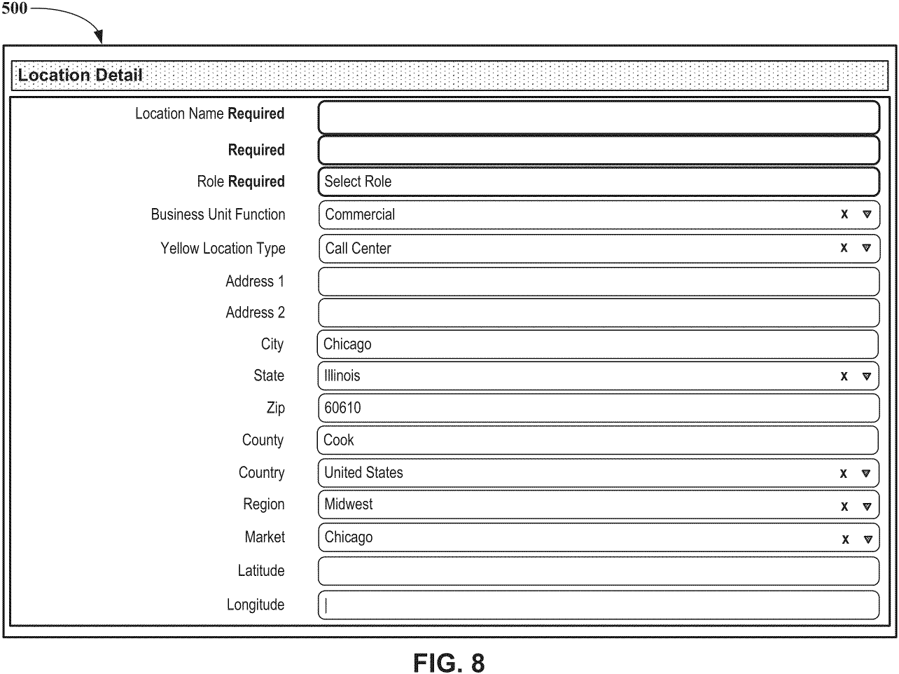

FIG. 7 illustrates an on-line app library 400 including analytic calculator 200 available for download onto a mobile device. The analytic calculator 200 may be available as a mobile app in on-line app libraries, such as the Google Play Store, among others. As such, the user can use the app independently of any other software application or data sets. At the user’s discretion, the output of the analytic calculator 200 from its operation on the mobile app can be sent to the email address of the user in various formats such as .xls or .pdf. However, should the user need to save the data from the output of the analytic calculator for future analysis, or desires that other data sets be used in conjunction with the analytic calculator, then the user has the ability to utilize the module library on the web application. The module library provides a number of structured data elements within a graphical user interface that allows for the data elements to be saved, as well as additional data to be added and subsequently modified (see FIG. 8).

FIG. 8 illustrates an exemplary location module 500 for the analytic calculator, in accordance with an exemplary embodiment. A user may input data such as location name, role, business unit function, location type, address, city, state, zip code, county, country, region, market, latitude, longitude, etc. into the location module. This data may be saved into memory for later use.

### Modifying and Creating Modules for Data Variables

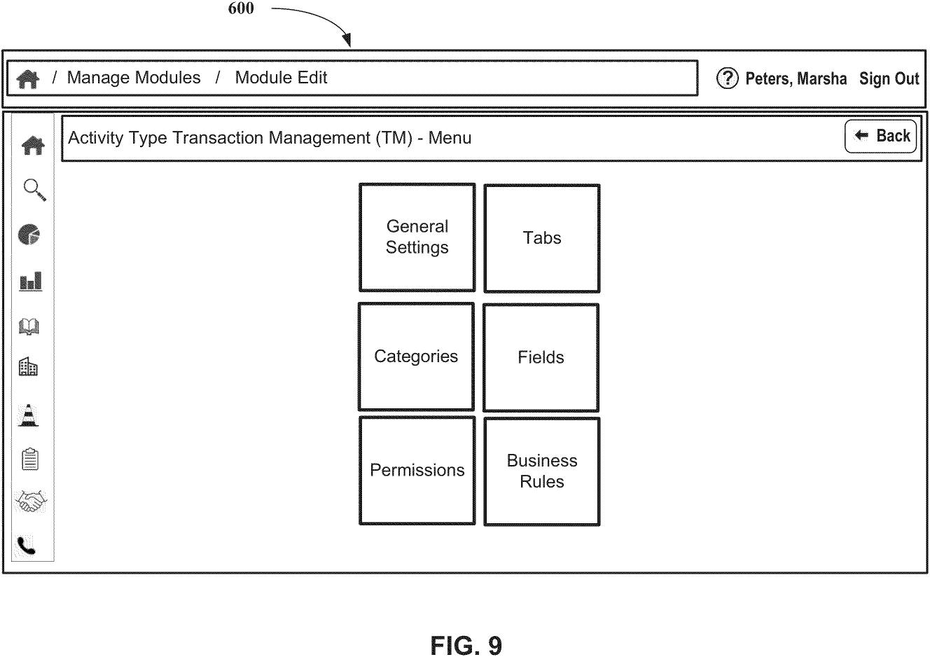

FIG. 9 illustrates an exemplary module creation menu 600 for the analytic calculator, in accordance with an exemplary embodiment. The web software application may provide for the same no code platform for the creation and modification of modules. If new data elements are desired, they can be added as well to the module selected from the module library. Using the administrative tool, a user can even create new modules to fulfill business requirements (see FIG. 9).

### Importing and Using Alternative Data Sets Within the AC

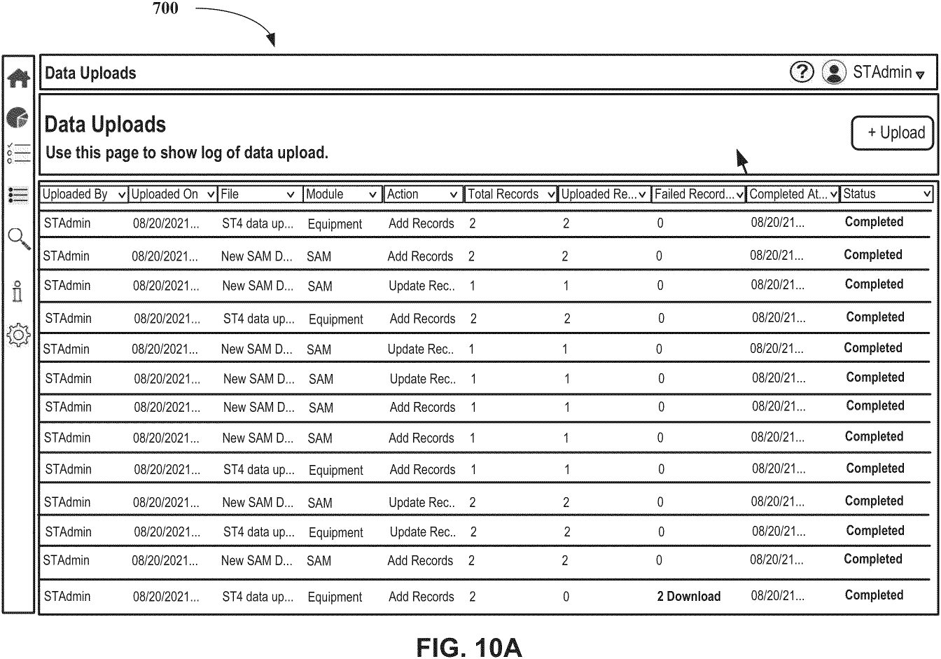

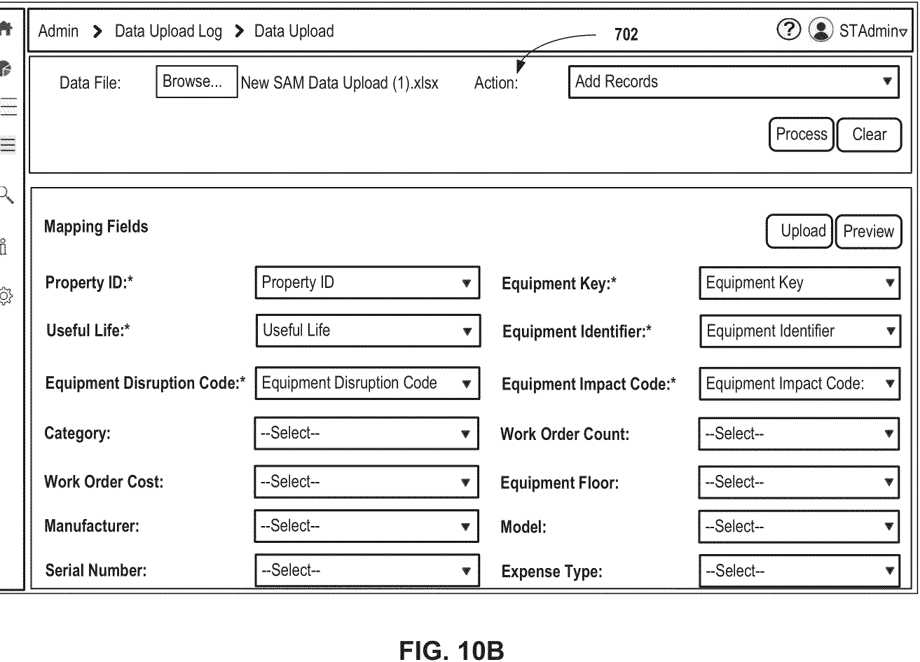

FIG. 10A illustrates data extraction, transform and load capabilities 700 for the analytic calculator, in accordance with an exemplary embodiment. Should the user have the need to reference or use other data sets from other databases or sources, the analytic calculator offers that ability to easily do that through the administrative tool. In computing, extract, transform, load (ETL) is the general procedure of copying data from one or more sources into a destination system which represents the data differently from the source(s) or in a different context than the source(s). The ETL process is often used in data warehousing. Data extraction involves extracting data from homogeneous or heterogeneous sources; data transformation processes data by data cleaning and transforming them into a proper storage format/structure for the purposes of querying and analysis; finally, data loading describes the insertion of data into the final target database such as an operational data store, a data mart, data lake or a data warehouse. The data can be mapped from the source, such as a spreadsheet to the appropriate fields with the Module Records 702 (see FIG. 10B).

Being able to load other data sets within the analytic calculator allows the user to leverage content such as prior financial transactions, all of the locations within a real estate portfolio, and other important information.

### Assessing a Portfolio of Historical Transaction Types

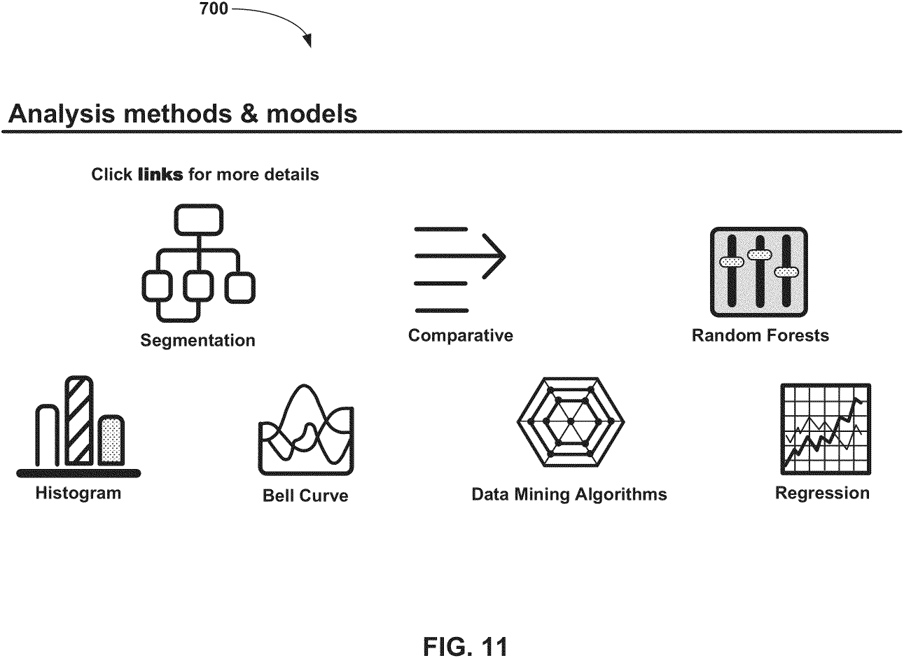

FIG. 11 illustrates examples of statistical methods utilized in the analytic calculator, in accordance with an exemplary embodiment. These examples include segmentation analysis, comparative analysis, random forests analysis, histogram analysis, bell curve analysis, data mining algorithms, and regression analysis. If the user creates a large data set of financial transactions either from using the analytic calculator or importing historical records (or both), the entire data set can now be systematically analyzed using the analytic calculator. For instance, the NPV of all prior leases can now be calculated. This creates the capability of additional comparative analysis to be made to transactions currently being analyzed, or historical trends and patterns. For example, a specific transaction could be viewed relative to any number of statistical methods, such as variance from the mean, within a pareto chart or within deciles of NPV values of the entire portfolio. The analytic calculator provides a statistics library to enable the user within the administrative tool to select different statistical methods, apply them to the output of a specific calculation and provide a result within the web application interface. This allows the user to have additional business intelligence regarding the transaction that is under consideration.

In some embodiments, data sets inputted into the analytic calculator and/or imported historical records can be included in a training data set. Generally speaking, a training data set can comprise a grouping of data points that can be used to train a predictive (e.g., machine learning) algorithm. Training data can come in a number of forms. For example, training data can be labeled (e.g., annotated) or unlabeled. For example, imported historical data can be associated with a label indicating whether the historical transaction was considered successful. In various embodiments, whether a transaction was considered successful can depend on a score of a transaction. For example, when a score for a transaction exceeds a predetermined threshold, the transaction can be deemed successful. As another example, when a score for a transaction falls below a predetermined threshold, the transaction can be deemed unsuccessful. In various embodiments, a training data set can comprise a mixture of labeled and unlabeled data. In some embodiments, unlabeled training data can be referred to as a test data set. In these embodiments, all or a portion of a test data set can be fed into a trained predictive algorithm to determine whether the training produced an accurate algorithm. In many embodiments, transaction data can be converted into vector format before it is labeled or before it is fed into a predictive algorithm. For example, one or more elements of a transaction and/or one or more variables as described herein can be concatenated together to create a vector.

In some embodiments, a training data set can be used to train a predictive algorithm. In various embodiments, a predictive algorithm can be trained as new transaction data is received and/or after a training data set is created. In some embodiments, a predictive algorithm can be trained on an already assembled training data set (e.g., a pre-purchased set). In these or other embodiments, training a predictive algorithm can comprise estimating internal parameters of a model configured to determine a value for a transaction. For example, a weight of one or more variables can be adjusted. In this way, the influence the one or more variables have on a prediction can be increased or decreased. In various embodiments, a predictive algorithm can be trained using unlabeled and/or labeled training data, otherwise known as a training dataset. In the same or different embodiments, a pre-trained predictive algorithm can be used, and the pre-trained algorithm can be re-trained on training data. In some embodiments, a predictive algorithm can also consider both historical and dynamic input from analytics calculator 200 (FIG. 2). In this way, a predictive algorithm can be trained iteratively as data is added to a training data set. In many embodiments, a predictive algorithm can be iteratively trained in real time as data is added to a training data set. In various embodiments, a predictive algorithm can be trained, at least in part, on a single transaction type’s data (e.g., only real property sales) or the type of transaction’s data can be weighted in a training data set. In this way, a predictive algorithm tailored to a type of transaction can be generated. In the same or different embodiments, a predictive algorithm tailored to a type of transaction can be used as a pre-trained algorithm for a similar transaction (e.g., real property sales can be used to train algorithms for real property leases). In several embodiments, due to a large amount of data needed to create and maintain a training data set, a predictive algorithm can use extensive data inputs to predict a value for a transaction. Due to these extensive data inputs, in many embodiments, creating, training, and/or using a predictive algorithm configured to value a transaction cannot practically be performed in a mind of a human being.

### AC Data Lake, Data Mining and Crowd Sourcing

The data that is being created by use of the analytic calculator, subject to user permissions, may be stripped of confidential information and stored within a centralized database. Likewise, user modifications to the calculator library or module library may also captured. These data sets can then be made available to other users of the analytic calculator for use for further comparative analysis, statistical modeling, and data mining.

In its simplest state, the analytic calculator, as disclosed herein, can provide a user with a valuable solution to provide the optimal structure to a financial transaction. However, the analytic calculator is scalable and configurable, allowing it to be used for large volumes and diversity of transactions. The application may support the optimization of a financial outcome in a holistic manner that is a paradigm shift in the industry at large.

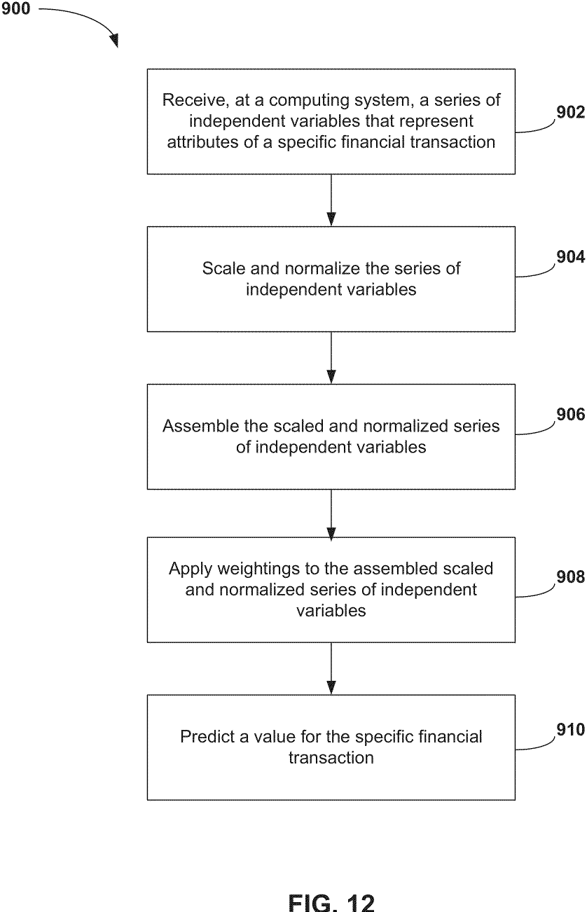

FIG. 12 is a flow chart illustrating an exemplary method 900 disclosed herein. The method 900 is a method of forecasting commercial financial transactions. The method includes receiving, at a computing system, a series of independent variables that represent attributes of a specific financial transaction (902), scaling and normalizing the series of independent variables (904), assembling the scaled and normalized series of independent variables (906), applying weightings to the assembled scaled and normalized series of independent variables (908), and predicting a value for the specific financial transaction (910).

Receiving the series of independent variables that represent attributes of a specific financial transaction (902) may include receiving a signal used to transmit the series of independent variables and processing the signal used to transmit the series of independent variables to extract the series of independent variables. Generally, the signal may be any wired or wireless signal that may be used to transmit a series of independent variables. Accordingly, the systems described herein may include an appropriate receiver or transceiver to receive such signals.

Scaling and normalizing the series of independent variables (904) may include transforming the series of independent variables, such that the features are within a specific range (scaling) and changing the shape of the distribution of the independent variables.

Assembling the scaled and normalized series of independent variables (906) may include combining the scaled and normalized series of independent variables into a data set. For example, each of the series of independent variables that have been scaling and normalizing may be a member of such a set.

Applying weightings to the assembled scaled and normalized series of independent variables (908) may include multiplying each member of the assembled scaled and normalized series of independent variables by one or more numbers or “weights.” For example, each member of the set of assembling the scaled and normalized series of independent variables may be multiplied by a weighting factor.

Predicting a value for the specific financial transaction (910) may include forecasting the financial value and/or consideration for the specific contractual agreement based on one or more of the assembled scaled and normalized series of independent variables as compared to prior outcomes which have similar attributes. Predicting a value for the specific financial transaction (910) may include predicting a score for the specific financial transaction (e.g., see FIG. 3).

In an example, the series of independent variables may include, but is not limited to, at least one of market, trade area, location, type of center, asset, lease, landlord, comparable assets, negotiator, and strategy. In an example, the series of independent variables may include, but is not limited to, at least one of purchase type (e.g., sale or lease), interest rate, and payment duration. In an example, the series of independent variables may include, but is not limited to at least one composite variable of multiple variables. The method 900 may be repeated for a series of specific contractual transactions forming a portfolio or a sub-portfolio.

An example embodiment of the systems and methods described herein may include a device for forecasting commercial real estate lease rent rates. The device for forecasting commercial real estate lease rent rates may include at least one processor and a memory. Accordingly, the systems and methods described herein may be implemented in a processor-based device. For example, the method described with respect to FIG. 12 may be implemented using the at least one processor. The at least one processor may implement one or more of the steps of FIG. 12. In some example embodiments, the steps of FIG. 12 may be executed across multiple processors. However, the systems and methods described herein may include a device for forecasting any type of commercial transaction.

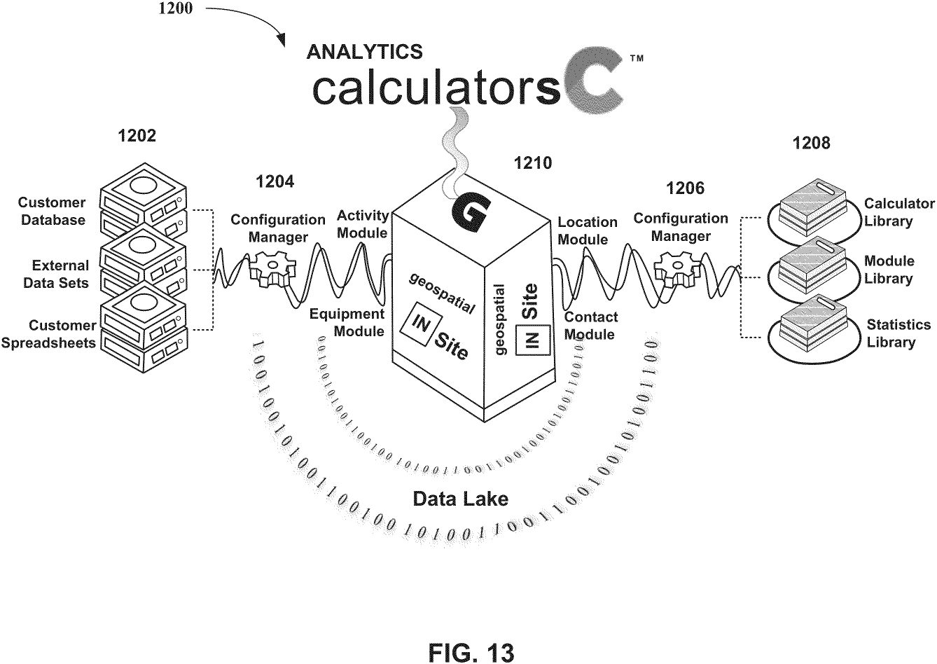

FIG. 13 is a system diagram illustrating an example system 1200 in accordance with the systems and methods described herein. The system 1200 includes databases, datasets, and spreadsheets 1202, configuration managers 1204, 1206, and a calculator library, module library, and statistics library 1208. The system 1200 may include an analytics calculator 1210 that implements the systems and methods described herein, for example, a method of forecasting commercial real estate lease rent rates.

The at least one processor can be any suitable component which can execute instructions or logic, including but not limited to a micro-controller, microprocessor, multi-core processor, integrated-circuit, application specific integrated circuit (ASIC), field programmable gate array (FGPA), programmable logic device (PLD), or any appropriate combination of these components.

The memory may be coupled to the at least one processor. The memory may be any suitable component which can store instructions, logic, or programs, including but not limited to non-volatile or volatile memory, read only memory (ROM), random access memory (RAM), FLASH memory, registers, magnetic hard disk, optical disk, or any combination of these components. The memory may store processor executable instructions. Accordingly, the memory may include instructions causing the at least one processor to receive, at the device, a series of independent variables that represent attributes of a specific commercial financial transaction. The memory may include instructions causing the at least one processor to scale and normalize the series of independent variables. Additionally, the memory may include instructions causing the at least one processor to assemble the scaled and normalized series of independent variables. The memory may also include instructions causing the at least one processor to apply weightings to the assembled scaled and normalized series of independent variables and predict a rental rate for the specific commercial financial transaction, among other types of financial transactions.

In an example embodiment, the memory further includes instructions causing the at least one processor to apply at least one of ordinary least squares, GLM, logistic regression, decision trees, random forests, or multivariate adaptive regression splines.

Generally speaking, a decision tree can comprise one or more analytic nodes connected by one or more branches. A number of different types of nodes can be present in a decision tree. For example, a node can be a decision node or a leaf node. In some embodiments, a decision node in a decision tree algorithm can classify data points into two or more classifications. For example, a decision node can classify a transaction based on a value of the transaction. In these or other embodiments, a leaf node can comprise a node where data points are of the same or similar classification. In this way, data points can be classified by being fed into a first decision node of a decision tree (known as a root node) and then passed through the branches to other decision nodes and leaf nodes. In various embodiments, classification of a datapoint can end when it reaches a leaf node. In some embodiments, a decision tree model can comprise a random forest model. Generally speaking, a random forest model can comprise an algorithm in which multiple decision trees are used in parallel to classify a data point. In various embodiments, a decision tree algorithm can comprise a gradient boost algorithm. Generally speaking, boosting is an ensemble learning method that builds consecutive small trees (some as small as one node), where each consecutive tree is focused on correcting an error from a previous tree. In some embodiments, an optimization algorithm can be used in combination with a boosted decision tree, thereby creating a gradient boosted algorithm. In various embodiments, an optimization algorithm can be configured to minimize a cost function (e.g., an error or a loss). In this way, a decision tree algorithm can be made more accurate than other predictive algorithms.

In an example embodiment, the series of independent variables may include at least one of market, trade area, location, type of center, asset, lease, landlord, comparable assets, negotiator, and strategy. The series of independent variables may include at least one composite variable of multiple variables.

In an example embodiment, the memory further includes instructions causing the at least one processor to generate a composite score of the specific commercial financial transaction, the composite score used as an independent variable in predicting the rental rate. The processing done by the at least one processor may be repeated for a series of specific commercial financial transaction, forming a portfolio or a sub-portfolio. In an example embodiment, the device may be further configured to predict rental rates for the specific commercial financial transaction for a plurality of scenarios. In an example embodiment, the device may be further configured to predict rental rates for the specific commercial financial transaction for a plurality of scenarios. In an example embodiment, the device may be further configured to predict the rental rate for the specific commercial financial transaction, including length of the term of tenancy.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A method of forecasting commercial financial transactions, comprising:
receiving, at a computing system, a series of independent variables that represent attributes of a specific financial transaction;
scaling and normalizing the series of independent variables;
assembling the scaled and normalized series of independent variables;
applying weightings to the assembled scaled and normalized series of independent variables;
analyzing data relative to past results from industry data and from portfolio data from the user; and
predicting a value for the specific financial transaction.

2. The method of claim 1, further comprising applying at least one of ordinary least squares, generalized linear models (GLM), logistic regression, random forests, decision trees, or multivariate adaptive regression splines.

3. The method of claim 1, wherein the series of independent variables comprises at least one of market, trade area, location, type of center, asset, lease, landlord, comparable assets, negotiator, and strategy.

4. The method of claim 1, wherein the series of independent variables comprises at least one composite variable of multiple variables.

5. The method of claim 1, further comprising generating a composite score of the specific financial transaction, the composite score used as an independent variable in predicting the value.

6. The method of claim 1, wherein the method is repeated for a series of specific commercial financial transactions, forming a portfolio or a sub-portfolio.

7. The method of claim 1, wherein the method further comprises predicting net present value for the specific commercial financial transaction for a plurality of scenarios.

8. The method of claim 1, wherein the value is a score.

9. The method of claim 1, wherein the value is a financial value.

10. A device for forecasting commercial financial transaction scores, comprising:
at least one processor; and
a memory, coupled to the at least one processor, the memory including instructions causing the at least one processor to:
receive, at the device, a series of independent variables that represent attributes of a specific commercial financial transaction;
scale and normalize the series of independent variables;
assemble the scaled and normalized series of independent variables;
apply weightings to the assembled scaled and normalized series of independent variables;
analyze data relative to past results from industry data and from portfolio data from the user; and
predict a score for the specific commercial financial transaction.

11. The device of claim 10, the memory further including instructions causing the at least one processor to apply at least one of ordinary least squares, generalized linear models (GLM), logistic regression, random forests, decision trees, or multivariate adaptive regression splines.

12. The device of claim 11, wherein the series of independent variables comprises at least one of market, trade area, location, type of center, asset, lease, landlord, comparable assets, negotiator, and strategy.

13. The device of claim 11, wherein the series of independent variables comprises at least one composite variable of multiple variables.

14. The device of claim 11, the memory further including instructions causing the at least one processor to generate a composite score of the specific commercial financial transaction, the composite score used as an independent variable in predicting the rental rate.

15. The device of claim 11, the device further configured to repeat calculations for a series of specific commercial financial transaction, forming a portfolio or a sub-portfolio.

16. The device of claim 11, the device further configured to predict net present value for the specific commercial financial transaction for a plurality of scenarios.
wherein the method further comprises predicting net present value for the specific commercial financial transaction for a plurality of scenarios.

17. The device of claim 11, the score is based on comparable financial transactions.

18. The device of claim 11, the score is a financial value.

19. An apparatus for forecasting commercial financial transaction scores, the apparatus configured to:
receive, at a computing system, a series of independent variables that represent attributes of a specific commercial financial transaction;
scale and normalize the series of independent variables;
assemble the scaled and normalized series of independent variables;
apply weightings to the assembled scaled and normalized series of independent variables; and
predict a score for the specific commercial financial transaction.

20. The apparatus of claim 19, further configured to apply at least one of ordinary least squares, generalized linear models (GLM), logistic regression, random forests, decision trees, or multivariate adaptive regression splines.
